(19) United States
(12) Patent Application Publication
(10) Pub. No.: US 2006/0148497 A1
(43) Pub. Date: Jul. 6, 2006

(54) Methods for setting up dispatch calls

(75) Inventors: Juan C. Fernandez, Boca Raton, FL (US); Rochelle J. Berman, Plantation, FL (US)

Correspondence Address: MOTOROLA, INC;INTELLECTUAL PROPERTY SECTION, LAW DEPT, 8000 WEST SUNRISE BLVD, FT LAUDERDAL, FL, 33322, US

(73) Assignee: Motorola, Inc.

(21) Appl. No.: 11/027,183

(22) Filed: Dec. 30, 2004

(51) Int. Cl. H04Q 7/20; H04B 7/00

(52) U.S. Cl. 455/507

(57) ABSTRACT

In the present technique for dispatch call setups, a determination (608) is made as to whether an unavailable mode to accept dispatch call requests has been enabled in response a dispatch call request identified by a dispatch caller identifier being received (604). If so, another determination (614) is made as to whether a custom greeting associated with the dispatch caller identifier is available, and when such a custom greeting is available, it is used to respond (616) to the dispatch call request.

### TECHNICAL FIELD

This invention relates generally to methods for setting up dispatch calls over a communication network.

### BACKGROUND

Dispatch calls generally use a forced-audio model where the target mobile station does not have to answer the call in order for the call to be set up. In other words, unlike traditional telephone system, a dispatch call is made at the time when the originator mobile station makes the call, assuming that the target mobile station is active. As a result, this can be extremely disruptive and intrusive for the user of the target mobile station, because the target mobile station automatically accepts the call without confirmation from the user. Although the user can previously set up the target mobile station to chirp back without speaking to indicate that the user is unavailable, the user of the originator mobile station is not given any reasons as to why the user of the target mobile station is unavailable, which can be frustrating for the user of the originator mobile station. Thus, the user of the originator mobile station may feel that the response is unsatisfactory, and attempt to contact the user of the target mobile station by pursuing other mechanisms. If, however, the user of the target mobile station forgot to set up the chirp back function beforehand, the user of the target mobile station may have to respond in order to end the call, which can be annoying for the user of the target mobile station. Essentially, the users of a dispatch call mobile station have very little control over their mobile station. As used herein, “dispatch” shall be understood to serve as an expression of convenience that encompasses various kinds of push-to-talk communications including networks that employ a dispatcher and those that do not.)

### BRIEF DESCRIPTION OF THE DRAWINGS

The above needs are at least partially met through provision of the dispatch call setup technique described in the following detailed description, particularly when studied in conjunction with the drawings, wherein:

FIG. 1 comprises a block diagram of a typical wireless dispatch communication system suitable for various embodiments of the invention;

FIG. 2 comprises a transmitter circuit according to various embodiments of the invention;

FIG. 3 comprises a call flow diagram of a dispatch call setup according to an embodiment of the invention implemented at the network controller;

FIG. 4 comprises a call flow diagram of a dispatch call setup according to an embodiment of the invention implemented at the mobile station;

FIG. 5 comprises a flow chart diagram of a custom greeting setup process according to one embodiment of the invention;

FIG. 6 comprises a flow chart diagram of a dispatch call setup process according to one embodiment of the invention; and

FIG. 7 comprises a flow chart diagram of an unavailable mode setup process according to one embodiment of the invention.

Skilled artisans will appreciate that elements in the figures are illustrated for simplicity and clarity and have not necessarily been drawn to scale. For example, the dimensions of some of the elements in the figures may be exaggerated relative to other elements to help improve understanding of various embodiments of the present invention. Also, common and well-understood elements that are useful or necessary in a commercially feasible embodiment are often not depicted in order to facilitate a less obstructed view of these various embodiments of the present invention.

### DETAILED DESCRIPTION

Generally speaking, pursuant to these various embodiments, responsive to receiving a dispatch call request identified by a dispatch caller identifier, a determination is made as to whether an unavailable mode to accept dispatch call requests has been enabled. If so, another determination is made as to whether a custom greeting associated with the dispatch caller identifier is available, and when such a custom greeting is available, it is used to respond to the dispatch call request. According to one embodiment, a default greeting is used as a response to the dispatch call request when a custom greeting is not available. The dispatch call request, in one embodiment, is further accepted when the unavailable mode has not been enabled. The dispatch call request is further logged in a recent call summary list.

In another embodiment, prior to the receipt of the dispatch call request, a determination is made as to whether a selected custom greeting should be associated with one or more unavailable time periods, and if so, the selected custom greeting is associated with these unavailable time period(s). In one embodiment of setting up the custom greetings, a determination is further made as to whether the selected custom greeting(s) should be associated with one or more dispatch call identifiers, and if so, an association as such is accordingly made. In a particular embodiment, the user is prompted for the selection of the custom greeting(s). In one embodiment, the selected custom greeting along with its association(s) is sent to a network controller. In another embodiment, the selected custom greeting along with its association(s) is saved at the mobile station.

According to various embodiments, prior to the determination as to whether the selected custom greeting should be associated with an unavailable time(s), one or more calendar items are downloaded and saved. Accordingly, one or more unavailable time periods to accept dispatch call requests are flagged based on the downloaded calendar items. In another embodiment, the user is prompted for the calendar item(s), followed by a determination as to whether there are any more calendar item(s) from the user. If not, one or more unavailable time periods to accept dispatch call requests are flagged based on the calendar item(s) from the user.

In various embodiments, when an unavailable time period to accept dispatch call requests has been detected, the unavailable mode is accordingly enabled based on the detected unavailable time period. In response to the unavailable mode being enabled, a transceiver of a mobile station is at least partially shut down. In one embodiment, prior to the detection of the unavailable time period, one or more custom greetings along with their corresponding association(s) are sent to a network controller that responds with these custom greetings responsive to the unavailable mode being enabled. In another embodiment, one or more available times to accept dispatch call requests are detected in which the unavailable mode is disabled based on these available times. A state of operability of the transceiver of the mobile state is further increased responsive to the unavailable mode being disabled.

Through these various teachings, a dispatch call setup process has been provided that, among other things, associates a custom greeting with a dispatch caller identifier. The various embodiments described also seamlessly integrate the user's calendar events in which an association can be created with these custom greetings. As a result, users can now have more control over greetings for rejecting a dispatch call request. Moreover, in one embodiment, because the custom greetings are stored at the network controller, the mobile station can be automatically shut down partially during the unavailable mode in order to save battery and reduce transmitter power. This implementation also ensures that the user of the mobile station is not interrupted at all during the unavailable mode. Through these various embodiments described, the user of the originator mobile station will be able to obtain more information through the custom greetings for a rejected dispatch call, while the user of the target mobile station can customize these custom greetings according to dispatch call identifier and unavailable time periods. As a result, a more user friendly and flexible dispatch call setup process has been provided through the various teachings described.

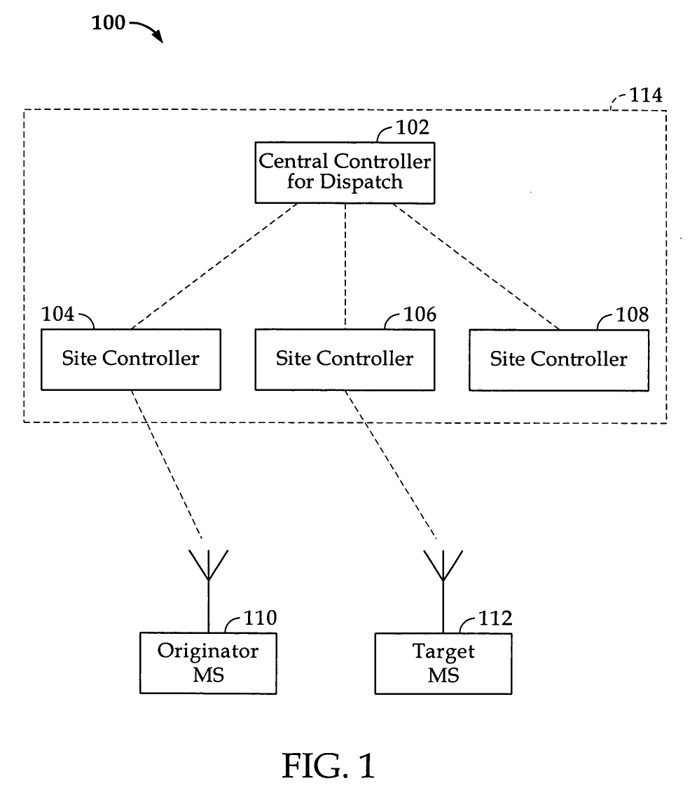

Referring now to the drawings, and in particular to FIG. 1, for purposes of providing an illustrative but non-exhaustive example to facilitate this description, a specific operational paradigm using a wireless dispatch communication system is shown and indicated generally at 100. Those skilled in the art, however, will recognize and appreciate that the specifics of this illustrative example are not specifics of the invention itself and that the teachings set forth herein are applicable in a variety of alternative settings. For example, since the teachings described are not platform dependent, they can be applied to various systems, such as, but not limited to, Code Division Multiple Access (CDMA) systems, Time Division Multiple Access (TDMA) systems, Universal Mobile Telecommunications Systems (“UMTSs”), and General Packet Radio Service (“GPRS”) systems. In fact, any communication networks that include the feature of dispatch calling are contemplated and are within the scope of the invention.

Referring now to the exemplary communication network shown in FIG. 1, a central controller 102 is operably coupled to multiple site controllers 104, 106, 108. The site controllers 104, 106, 108 provide services to multiple mobile stations (“MSs”) 110, 112 (two shown). Since current cell phones have many similar functions to that of computer devices, a mobile station will be herein used to refer to any device that can transmit data packets, which includes, but is not limited to, cell phones, personal digital assistants, and/or computers. In this example, MS 110 is an originator MS that is trying to communicate with MS 112, which would be referred to as the target MS. In other words, the originator MS 110 will initiate a dispatch call setup with the target MS 112, which may result in a dispatch call being setup between the two MSs. Specifically, the originator MS 110 sends a dispatch call request to the site controller 104, and the target MS 112, for example, responds to the site controller 106 to start the communication. Of course, in various embodiments, a response is not needed from the target MS 112. In this case, the central controller 102 will accordingly route the appropriate response to the originator MS 110 via the site controller 104. The central controller 102 along with the site controllers 104, 106, 108 will herein be referred to as a network controller 114 to emphasize that the various teachings described can process a dispatch call through either the central controller 102 and/or the serving site controllers 104, 106, 108. The communication system 100 shown is a typical exemplary structure of a dispatch call network for an originator MS and a target MS shown.

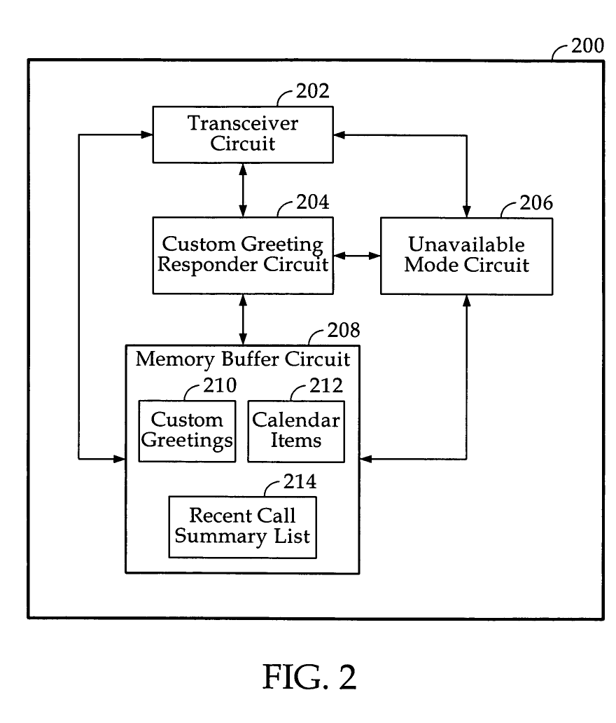

Referring to FIG. 2, a transmitter circuit according to various embodiments of the invention is shown and indicated generally at 200. These various teachings contemplate either adapting the target MS 112 and/or the network controller to fully or partially implement the various embodiments described. As a result, the present transmitter circuit is given as one of many configurations and circuitry topologies available, and these various alternative embodiments, although not shown, are readily appreciated by one skilled in the art. Thus, they are within the scope of the various teachings described. Moreover, circuit refers to any type of executable instructions that can be implemented as hardware, firmware, and/or software, which are all within the scope of the various teachings described. In this exemplary transmitter circuit 200 shown, a transceiver circuit 202 for receiving the dispatch call requests is operably coupled to a custom greeting responder circuit 204 for responding to the dispatch call requests, an unavailable mode circuit 206 for enabling and disabling the unavailable mode to reject or accept these dispatch call requests, and a memory buffer circuit 208 for storing the various custom greetings 210, the calendar items 212, and the recent call summary list 214.

As an example, a dispatch call request is received at the transceiver circuit 202, which, in response, sends the request to the unavailable mode circuit 206 for a response to the request and the memory buffer circuit 208 for storage of the request in the recent call summary list 214. The unavailable mode circuit determines whether the MS is currently in the unavailable mode, and if so, the request is forwarded to the custom greeting responder circuit 204, which responds with either (1) a custom greeting that is associated with an unavailable time period and/or a dispatch call identifier contained in the dispatch call request or (2) a default greeting when the custom greeting is not available. The custom and default greetings 210 are specifically obtained by the custom greeting responder circuit 204 from the memory buffer circuit 208.

Another scenario is that when the transceiver circuit 202 receives custom greetings from the user, the transceiver circuit accordingly forwards these custom greetings to be stored in the memory buffer circuit 208. The transceiver circuit 202 may also receive an instruction from the user to enable the unavailable mode, and if so, the transceiver circuit 202 forwards the instruction to the unavailable mode circuit 206 for proper execution. The unavailable mode circuit 206 also tracks the calendar items to either enable or disable the unavailable mode at various time periods. As a result, once everything is customized by the user, the custom greeting responder circuit 204 and the unavailable mode circuit 206 automatically respond according to the customization preset by the user.

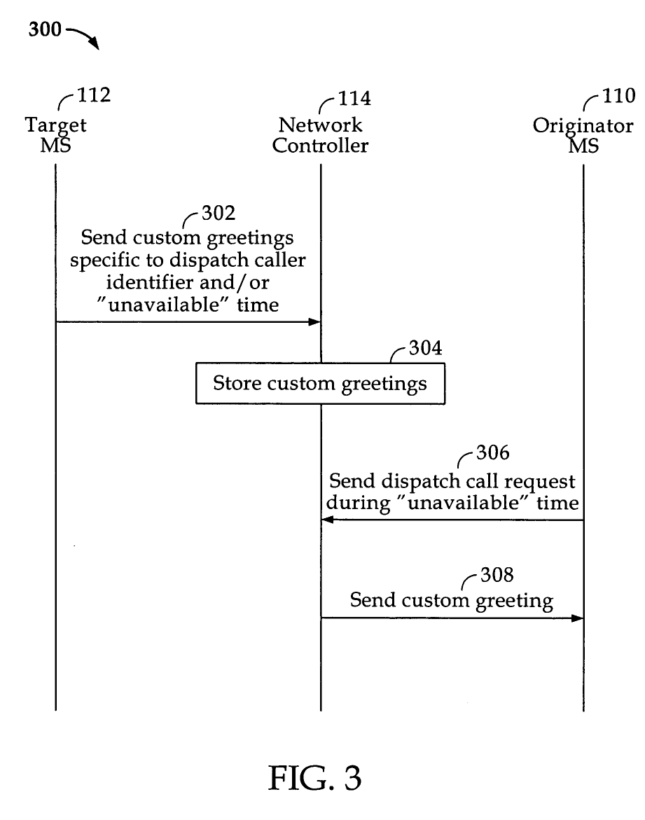

Turning now to FIG. 3, a call flow diagram of a dispatch call setup according to one embodiment implemented at the network controller is shown and indicated generally at 300. In this embodiment shown, since the network controller 114 is adapted with various embodiments of the invention, the target MS 112 is not alerted when a dispatch call request is received during the unavailable mode. In fact, in this embodiment, since it is contemplated that no response is needed from the target MS 112, the transmitter of the target MS is preferably shut down partially to save battery life and reduce transmitter power usage. As shown, a user of the target MS sends 302 custom greetings that may be specific to the dispatch call identifier and/or the unavailable time periods to the network controller 114, which accordingly stores 304 these custom greetings along with their associations. From these stored custom greetings, the network controller, in response to a dispatch call request 306 to the target MS, sends the custom greeting to avoid disturbance of the target MS. In particular, as shown, the target MS is not alerted of the dispatch call request during this unavailable time.

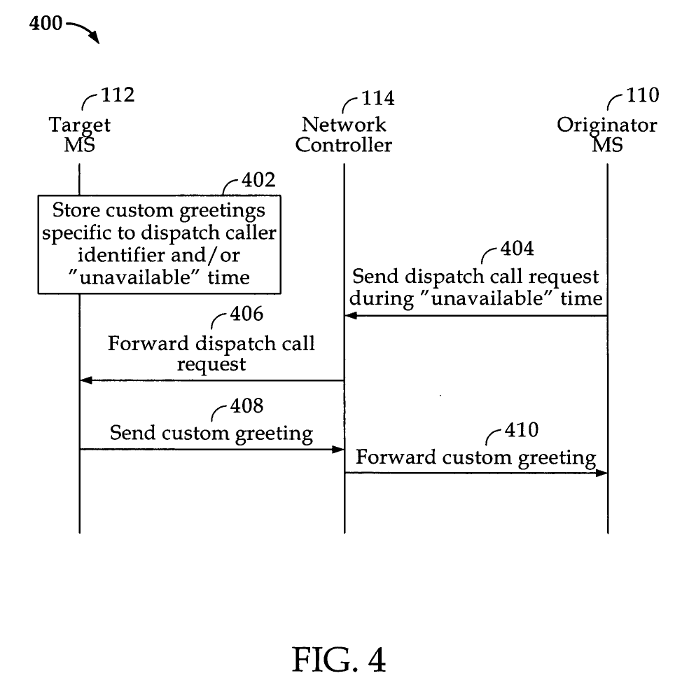

Turning now to FIG. 4, a call flow diagram of a dispatch call setup according to one embodiment implemented at the mobile station is shown and indicated generally at 400. In this particular call flow diagram shown, because the MS is modified to process the dispatch calls itself, no modification of the network controller 114 is required to accommodate the various teachings described. In this embodiment shown, the default greeting and/or custom greetings associated with the dispatch caller identifier and/or unavailable time periods are stored 402 at the target MS 112 itself. The call flow starts with a dispatch call request being sent 404 from the originator MS 110 to the network controller 114 during an unavailable time period of the target MS 112. The network controller 114, in turn, forwards 406 the dispatch call request to the target MS for processing. The target MS then automatically sends 408 a custom greeting to the network controller 114 responsive to the dispatch call request. The network controller 114 accordingly forwards 410 the custom greeting to the originator MS. Since the custom greetings are stored at the target MS 112, the dispatch call requests are processed by the target MS.

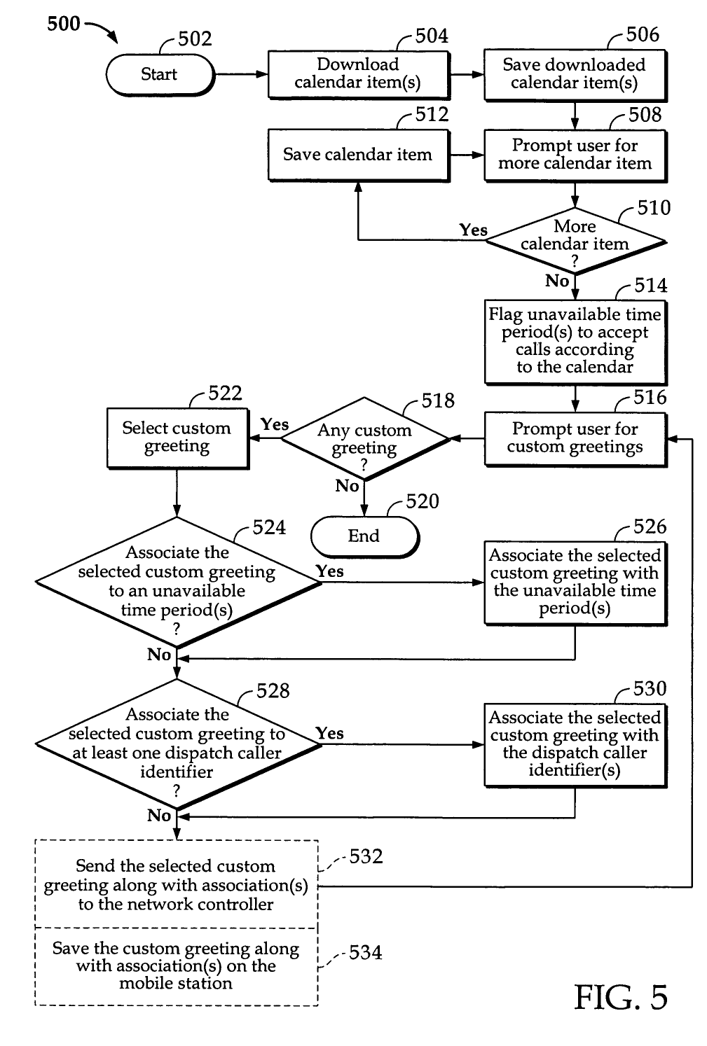

Referring to FIG. 5, a flow chart diagram of a custom greeting setup process according to one embodiment is shown and indicated generally at 500. These processes, as shown, can be implemented fully or partially at either the target MS 112 or network controller 114. Moreover, as one skilled in the art can readily appreciate, any of the processes shown can be altered in multiple ways to achieve the same functions and results of the various teachings described. As a result, these processes shown are one exemplary embodiment of multiple variation embodiments that may not be specifically shown. These other embodiments, however, are within the scope of the various teachings described.

In this particular example shown, the process is initiated 502 with one or more calendar items being downloaded 504 either to the mobile station and/or network controller, depending upon the specific embodiment implemented. These downloaded calendar items are then optionally saved 506. Furthermore, in one embodiment, the user can be optionally prompted 508 to enter more calendar items, which is followed by a determination 510 as to whether there are any more calendar items available. If so, the process saves 512 the calendar item, and keeps looping back until there are no more calendar items. In this case, one or more unavailable time periods to accept dispatch call requests are flagged 514 based on these calendar items. The user is also prompted 516 for the selection of any custom greeting(s) for each flagged unavailable time period. The process next determines 518 whether any custom greeting has been selected by the user. If not, which means the user has finished selecting custom greetings for each flagged unavailable time period, the process ends 520.

If a custom greeting has been selected 522, however, it is determined 524 whether the selected custom greeting should be associated with any of the flagged unavailable time periods. If so, the process accordingly makes such an association 526, and next determines 528 whether the selected custom greeting should be associated with one or more dispatch caller identifiers. If so, the process again makes such as association 530 with the selected custom greeting. The selected custom greeting along with its association(s) are then either sent 532 to the network controller for the embodiment where the custom greetings are stored at the network controller or saved 534 at the mobile station for the embodiment where the custom greetings are saved at the mobile station. After which, the process loops back to prompt 516 the user for a selection of a next custom greeting. This subroutine is repeated until the user fails to select a custom greeting 518, and the process comes to an end 520.

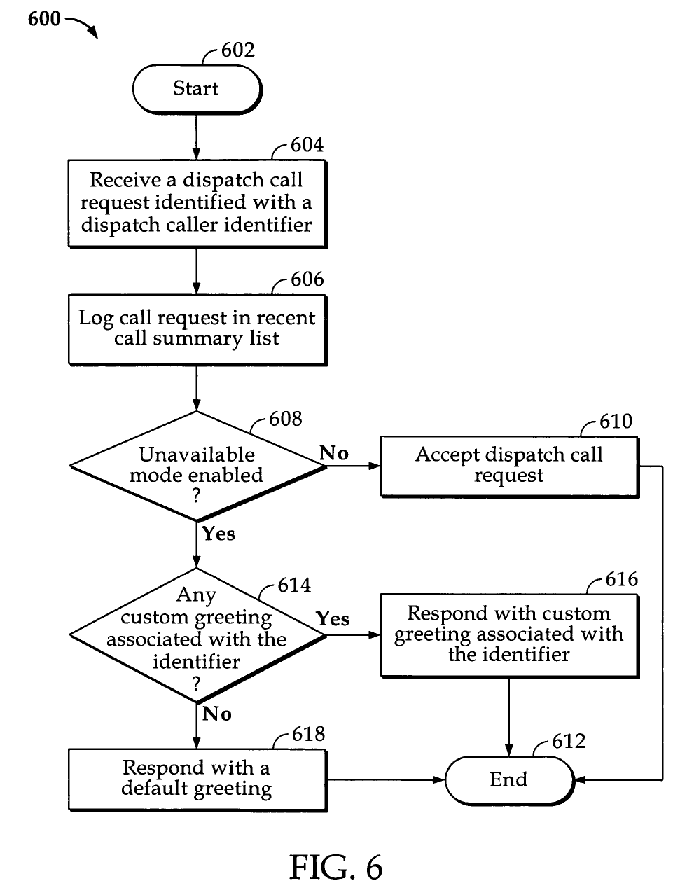

Turning now to FIG. 6, a flow chart diagram of a dispatch call setup process according to one embodiment is shown and indicated generally at 600. This process starts 602 by receiving 604 a dispatch call request, which is identified with a dispatch caller identifier. Currently, in the prior art, the dispatch call request itself already includes the dispatch caller identifier, and thus, the existing data structure of the dispatch call request can be used with the various teachings described without modification. As typically done in the prior art, the dispatch call request is logged 606 in a recent call summary list. The process then determines 608 whether the target MS currently has the unavailable mode enabled. If not, the dispatch call request is automatically accepted 610, which concludes 612 the process.

If, however, the unavailable mode is enabled, the process next determines 614 whether there is a custom greeting available that is associated with this dispatch caller identifier indicated in the dispatch call request. If so, the process accordingly responds 616 with the custom greeting associated with the dispatch call identifier, which may also be specific to this unavailable time period. Otherwise, the process will respond 618 with a default greeting, and the process ends 612 at this point.

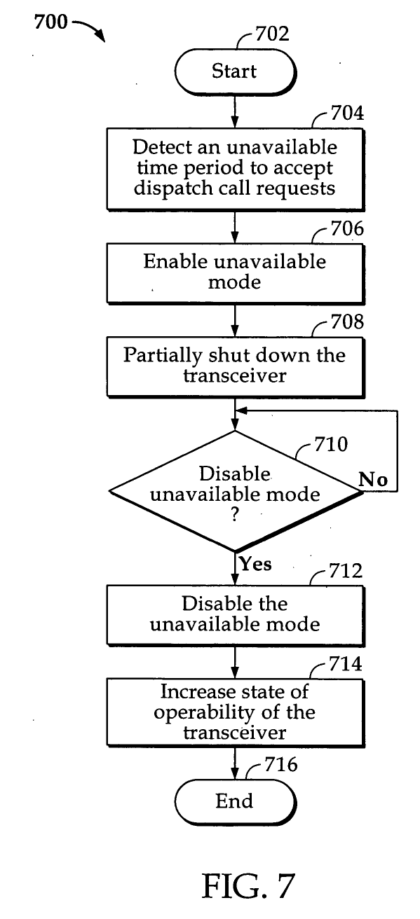

Turning now to FIG. 7, a flow chart diagram of an unavailable mode setup process according to one embodiment is shown and indicated generally at 700. This process is generally implemented at the MS in order to partially shut down the transceiver of the mobile station during the unavailable mode. If the custom greetings are already saved at the network controller 114, the MS does not necessarily have to be at full reception power during the unavailable mode. As such, in order to save battery power and/or reduce transmitter power, the transceiver of the MS is adapted to partially shut down when the unavailable mode is enabled and increase state of operability when the available mode is disabled (i.e., the available mode).

The process starts 702 with a detection 704 of an unavailable time period to accept dispatch call requests, which will trigger the unavailable mode being enabled 706. In response to the unavailable mode being enabled, the transceiver is partially shut down 708. The process then continuously checks to determine 710 whether the unavailable mode should be disabled, which can happen either by user selection or based on the calendar item(s) of available time periods to accept dispatch call request. If, in fact, the unavailable mode should be disabled, the process accordingly disables 712 the unavailable mode, and responsive to this, the process increases 714 the state of operability of the transceiver, which brings the process to an end 716.

With these various teachings shown, a novel dispatch call setup process has been provided that, among other things, associates a custom greeting with a dispatch caller identifier and/or calendar events of available and unavailable time periods to accept dispatch call requests. As a result, seamless integration of the user's calendar events with specific time period availability is achieved, coupled with more customization that is specific to the dispatch caller identifier. The users now, more than ever, are given greater control over custom and default greetings for rejecting a dispatch call request. Moreover, in one embodiment, since the greetings are stored at the network controller, the MS can be automatically shut down partially during the unavailable mode in order to save battery power and reduce transmitter power. This implementation also ensures that the user of the mobile station is not interrupted at all during the unavailable mode. The user of the target MS will be able to obtain more information through the custom greetings for a rejected dispatch call, while the user of the originator MS can customize these custom greetings according to the dispatch call identifier and unavailable time periods. As a result, a more user friendly and flexible dispatch call setup process has been provided through the various teachings described.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

We claim:

1. A method of responding to dispatch call requests comprising:
receiving a dispatch call request identified by a dispatch caller identifier;
determining whether an unavailable mode to accept the dispatch call requests has been enabled;
determining whether a custom greeting associated with the dispatch caller identifier is available when the unavailable mode has been enabled;
responding with the custom greeting associated with the dispatch caller identifier when a custom greeting associated with the dispatch caller identifier is available.

2. The method according to claim 1 further comprising:
accepting the dispatch call request when the unavailable mode has not been enabled.

3. The method according to claim 1 further comprising:
responding with a default greeting when a custom greeting associated with the dispatch call identifier is not available.

4. The method according to claim 1 further comprising, prior to receiving the dispatch call request identified by the dispatch caller identifier:
detecting an unavailable time period to accept dispatch call requests;
enabling the unavailable mode based on the unavailable time period to accept dispatch call requests;
at least partially shutting down a transceiver at a mobile station responsive to the unavailable mode being enabled.

5. The method according to claim 4 further comprising:
detecting an available time period to accept dispatch call requests;
disabling the unavailable mode based on the available time period to accept dispatch call requests;
increasing a state of operability of the transceiver at the mobile station responsive to the unavailable mode being disabled.

6. The method according to claim 1 further comprising, prior to receiving the dispatch call request identified by the dispatch caller identifier:
selecting a custom greeting to provide for a selected custom greeting;
determining whether the selected custom greeting should be associated with at least one unavailable time period to accept dispatch call requests;
associating the selected custom greeting with the at least one unavailable time period to accept dispatch call requests when the selected custom greeting should be associated with the at least one unavailable time period to accept dispatch call requests.

7. The method according to claim 6 further comprising:
sending the selected custom greeting along with its association with a network controller.

8. The method according to claim 6 further comprising:
saving the selected custom greeting along with its association at a mobile station.

9. The method according to claim 6 further comprising, prior to determining whether the selected custom greeting should be associated with at least one unavailable time period to accept dispatch call requests:
downloading at least one calendar item to provide for at least one downloaded calendar item;
saving the at least one downloaded calendar item;
flagging at least one unavailable time period to accept dispatch call requests based on the at least one downloaded calendar item.

10. The method according to claim 6 further comprising, prior to determining whether the custom greeting should be associated with at least one unavailable time period to accept dispatch call requests:
prompting a user for at least one calendar item;
determining whether there are any more calendar items;
saving at least one calendar item from the user when there are more calendar items;
flagging at least one unavailable time period to accept dispatch call requests based on the at least one calendar item from the user.

11. The method according to claim 1 further comprising, prior to receiving the dispatch call request identified by the dispatch caller identifier:
selecting a custom greeting to provide a selected custom greeting;
determining whether the selected custom greeting should be associated with at least one dispatch caller identifier;
associating the selected custom greeting with the at least one dispatch caller identifier when the selected custom greeting should be associated with the at least one dispatch caller identifier.

12. The method according to claim 11 further comprising:
sending the selected custom greeting along with its association with a network controller.

13. The method according to claim 11 further comprising:
saving the selected custom greeting along with its association at a mobile station.

14. The method according to claim 11 further comprising, prior to selecting a custom greeting:
prompting a user for at least one custom greeting;
determining whether a custom greeting is available for selection.

15. The method according to claim 1 further comprising, prior to determining whether the unavailable mode to accept dispatch call requests has been enabled:
logging the dispatch call request identified by the dispatch caller identifier in a recent calls summary list.

16. A method of responding to dispatch call requests comprising:
detecting an unavailable time period to accept dispatch call requests;
enabling an unavailable mode based on the unavailable time period to accept dispatch call requests;
at least partially shutting down a transceiver at a mobile station responsive to the unavailable mode being enabled.

17. The method according to claim 16 further comprising, prior to detecting an unavailable time period to accept dispatch call requests:
sending at least one custom greeting along with at least one association with a dispatch caller identifier to a center controller that responds with the at least one custom greeting based on the at least one association responsive to the unavailable mode being enabled.

18. The method according to claim 16 further comprising:
detecting an available time period to accept dispatch call requests;
disabling the unavailable mode based on the available time period to accept dispatch call requests;
increasing a state of operability of the transceiver of the mobile station responsive to the unavailable mode being disabled.

19. An apparatus for responding to dispatch call requests comprising:
a transceiver circuit that receives a dispatch call request identified by a dispatch caller identifier;
an unavailable mode circuit operably coupled to the transceiver circuit, wherein the unavailable mode circuit determines whether an unavailable mode to accept dispatch call requests has been enabled responsive to the dispatch call request;
a custom greeting responder circuit operably coupled to the unavailable mode circuit, wherein the custom greeting responder circuit determines whether a custom greeting associated with the dispatch caller identifier is available responsive to the unavailable mode being enabled and that responds with a custom greeting associated with the dispatch caller identifier responsive a custom greeting associated with the dispatch caller identifier being available.

20. The apparatus as defined in claim 19, wherein the unavailable mode circuit further enables the unavailable mode responsive to a detection of an unavailable time period to accept dispatch call requests and at least partially shuts down the transceiver circuit responsive to the unavailable mode being enabled.
